(19) United States
(12) Patent Application Publication
(10) Pub. No.: US 2026/0336422 A1
(43) Pub. Date: Oct. 29, 2026

(54) WINDING SWITCHING SYSTEM FOR VEHICLE MOTOR, CONTROL DEVICE, CONTROL METHOD FOR VEHICLE MOTOR, AND COMPUTER PROGRAM

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventors: Hiroki SASAKURA, Osaka-shi, Osaka (JP); Masaki TSUDA, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 19/117,775

(22) PCT Filed: Jan. 16, 2023
(86) PCT No.: PCT/JP2023/000923

§ 371 Date: Apr. 2, 2025

(30) Foreign Application Priority Data
Oct. 7, 2022 (JP) 2022-162243

(51) Int. Cl. B60L 15/00; B60L 15/20; H02M 7/537

(52) U.S. Cl. CPC B60L 15/007; B60L 15/20; H02M 7/537; B60L 2210/40; B60L 2240/486; B60L 2240/547

(57) ABSTRACT

A winding switching system includes: a drive motor configured to drive a wheel of a vehicle; a control device configured to control the drive motor; a power converter configured to convert DC power output from a battery into AC power and supply the AC power to the drive motor; and a winding switching device configured to switch a connection state of a plurality of windings in the drive motor between a first connection state and a second connection state. The control device includes: a torque control unit configured to change an output torque of the drive motor by changing an AC current output from the power converter at a predetermined gear shift timing of the vehicle; and a switching control unit configured to cause the winding switching device to switch from the first connection state to the second connection state after the AC current has changed.

### CROSS-REFERENCE TO RELATED APPLICATIONS

This application is the U.S. national stage of PCT/JP2023/000923 filed on Jan. 16, 2023, which claims priority of Japanese Patent Application No. JP 2022-162243 filed on Oct. 7, 2022, the contents of which are incorporated herein.

### TECHNICAL FIELD

The present disclosure relates to a winding switching system for a vehicle motor, a control device, a control method for a vehicle motor, and a computer program.

### BACKGROUND

JP 2018-166386A discloses that, in a vehicle that does not have a stepped transmission and in which the wheels are driven by a drive motor, such as an electric vehicle or a hybrid vehicle, a virtual shift change is produced by performing torque fluctuation control in which the torque of the drive motor is reduced by a set fluctuation amount and then increased.

The virtual shift change in the vehicle disclosed in JP2018-166386A is not an actual gear shift performed by a stepped transmission, but is realized at the expense of the traveling performance of the vehicle.

### SUMMARY

A winding switching system for a vehicle motor according to one aspect of the present disclosure includes: a drive motor configured to drive a wheel of a vehicle; a control device configured to control the drive motor; a power converter configured to convert DC power output from a battery into AC power and supply the AC power to the drive motor; and a winding switching device configured to switch a connection state of a plurality of windings in the drive motor between a first connection state and a second connection state, in which the control device includes: a torque control unit configured to change an output torque of the drive motor by changing an AC current output from the power converter at a predetermined gear shift timing of the vehicle; and a switching control unit configured to cause the winding switching device to switch from the first connection state to the second connection state after the AC current has changed.

The present disclosure can be realized not only as a winding switching system for a vehicle motor having the above-described characteristic configuration, but also as a control device included in a winding switching system for a vehicle motor, or as a control method for a vehicle motor having the characteristic processing in the control device as steps. The present disclosure can be realized as a computer program that causes a computer to function as a control device, or a portion or all of the control device can be realized as a semiconductor integrated circuit.

### Advantageous Effects

According to the present disclosure, it is possible to efficiently utilize the performance of the drive motor of an electric vehicle while providing the driver with a gear shift sensation similar to that of a stepped transmission.

### BRIEF DESCRIPTION OF DRAWINGS

FIG. 1 is a diagram showing an example of a configuration of a winding switching system according to a first embodiment.

FIG. 2 is a block diagram illustrating an example of a hardware configuration of a control device.

FIG. 3 is a circuit diagram showing an example of a configuration of a winding switching device according to the first embodiment.

FIG. 4 is a timing chart showing an example of switching timing for windings of a motor in the winding switching system according to the first embodiment.

FIG. 5 is a flowchart showing an example of electrical upshifting processing performed by the control device according to the first embodiment.

FIG. 6 is a flowchart showing an example of electrical downshifting processing performed by the control device according to the first embodiment.

FIG. 7 is a circuit diagram showing an example of a configuration of a winding switching device according to a second embodiment.

FIG. 8 is a timing chart showing an example of switching timing for windings of a motor in a winding switching system according to a third embodiment.

FIG. 9 is a timing chart showing an example of switching timing for windings of a motor in a winding switching system according to a fourth embodiment.

FIG. 10 is a timing chart showing an example of virtual gear shift control processing in a winding switching system according to a fifth embodiment.

FIG. 11 is a flowchart showing an example of virtual gear shift processing performed by a control device according to the fifth embodiment.

FIG. 12 is a functional block diagram illustrating an example of functions of a control device according to a sixth embodiment.

FIG. 18 is a flowchart showing an example of mandatory upshifting judgment processing performed by the control device according to the sixth embodiment.

FIG. 14 is a flowchart showing an example of mandatory downshifting judgment processing performed by the control device according to the sixth embodiment.

### DETAILED DESCRIPTION OF PREFERRED EMBODIMENTS

Hereinafter, an overview of embodiments of the present disclosure will be listed and described.

In a first aspect, a winding switching system for a vehicle motor according to the present embodiment includes: a drive motor configured to drive a wheel of a vehicle; a control device configured to control the drive motor; a power converter configured to convert DC power output from a battery into AC power and supply the AC power to the drive motor; and a winding switching device configured to switch a connection state of a plurality of windings in the drive motor between a first connection state and a second connection state, in which the control device includes: a torque control unit configured to change an output torque of the drive motor by changing an AC current output from the power converter at a predetermined gear shift timing of the vehicle; and a switching control unit configured to cause the winding switching device to switch from the first connection state to the second connection state after the AC current has changed. As a result, the connection state of the windings of the drive motor is switched from the first connection state to the second connection state, and therefore it is possible to efficiently utilize the performance of the drive motor to realize a gear shift (hereinafter also referred to as an “electrical gear shift”) equivalent to that realized by a mechanical transmission. Furthermore, by changing the output torque of the drive motor in accordance with the switching of the connection state of the windings of the drive motor, it is possible to provide the driver with a gear shift sensation similar to that of a mechanical transmission.

In a second aspect according to the first aspect, the torque control unit may reduce the output torque of the drive motor by reducing the AC current output from the power converter at a first gear shift timing, and the switching control unit may cause the winding switching device to switch from the first connection state to the second connection state after the AC current has decreased to a first target value or less. As a result, it is possible to realize an electrical gear shift similar to upshifting with a mechanical transmission while the vehicle is accelerating or maintaining speed.

In a third aspect, according to the second aspect, the torque control unit may reduce the output torque of the drive motor by reducing the AC current output from the power converter at a second gear shift timing different from the first gear shift timing, and the switching control unit may cause the winding switching device to switch from the second connection state to the first connection state after the AC current has decreased to the first target value or less. As a result, it is possible to realize an electrical gear shift similar to downshifting with a mechanical transmission while the vehicle is accelerating or maintaining speed.

In a fourth aspect according to the first aspect, the torque control unit may increase the output torque of the drive motor by increasing the AC current output from the power converter at the first gear shift timing, and the switching control unit may cause the winding switching device to switch from the first connection state to the second connection state after the AC current has increased to a second target value or more. Accordingly, it is possible to realize an electrical gear shift similar to upshifting with a mechanical transmission while the drive motor is performing regenerative braking.

In a fifth aspect according to the fourth aspect, the torque control unit may increase the output torque of the drive motor by increasing the AC current output from the power converter at a second gear shift timing different from the first gear shift timing, and the switching control unit may cause the winding switching device to switch from the second connection state to the first connection state after the AC current has increased to a second target value or more. Accordingly, it is possible to realize an electrical gear shift similar to downshifting with a mechanical transmission while the drive motor is performing regenerative braking.

In a sixth aspect according to any one of the first through the fifth aspects, the second connection state may be a connection state for the driving motor to output a lower torque than in the first connection state at the same rotation speed. As a result, it is possible to switch the connection state of the windings of the drive motor between a high torque, low speed first connection state and a low-torque, high-speed second connection state.

In a seventh aspect according to the sixth aspect, the control device may further include a first determination unit configured to determine, when the connection state of the plurality of windings is the first connection state, a timing before an induced voltage generated in the windings exceeds an output voltage of the battery, as a first mandatory gear shift timing, the torque control unit may change the output torque of the drive motor by changing the AC current output from the power converter at the first mandatory gear shift timing determined by the first determination unit, and the switching control unit may cause the winding switching device to switch from the first connection state to the second connection state after the AC current has changed. If the induced voltage generated in the windings exceeds the output voltage of the battery, the current flowing in the windings can no longer be changed to zero. If a relay switches the connection state of a winding while current is flowing through the winding, the relay may be damaged. With the above-described configuration, when the connection state of the windings is switched from the first connection state to the second connection state, the current flowing through the windings can be suppressed, and the relay can be protected.

In an eighth aspect according to the seventh aspect, the first determination unit may determine, as the first mandatory gear shift timing, a timing at which a physical quantity related to the induced voltage exceeds a first threshold value corresponding to the output voltage of the battery. As a result, it is possible to use a physical quantity related to the induced voltage to accurately determine the timing before the induced voltage exceeds the output voltage of the battery.

In a ninth aspect according to the eighth aspect, the physical quantity may be one of a voltage in the windings, a rotation speed of the drive motor, a current flowing through the windings, and the output torque of the drive motor. As a result, the timing before the induced voltage exceeds the output voltage of the battery can be accurately determined using one of the following: the voltage in the windings, the rotation speed of the motor, the current flowing through the windings, and the output torque of the motor, all of which can be easily detected by sensors.

In a tenth aspect accordin to any one of the seventh through the ninth aspect, the control device may further include: a judgment unit configured to, when the connection state of the plurality of windings is the second connection state, judge whether or not the induced voltage exceeds the output voltage of the battery after the connection state of the windings has been switched from the second connection state to the first connection state; and a prohibition unit configured to prohibit the switching control unit from switching the connection state of the windings if the judgment unit judges that the induced voltage exceeds the output voltage of the battery. As a result, the induced voltage of the windings is prevented from exceeding the output voltage of the battery after the connection state of the windings has been switched from the second connection state to the first connection state. Thus, the relay can be protected from damage.

In an eleventh aspect according to any one of the seventh through the tenth aspects, the control device may further include a second determination unit configured to, when the connection state of the plurality of windings is the second connection state, determine a timing after the induced voltage has become less than or equal to the output voltage of the battery after the connection state of the plurality of windings has been switched from the second connection state to the first connection state, as a second mandatory gear shift timing, the torque control unit may change the output torque of the drive motor by changing the AC current output from the power converter at the second mandatory gear shift timing determined by the second determination unit, and the switching control unit may cause the winding switching device to switch from the second connection state to the first connection state after the AC current has changed. As a result, the induced voltage of the windings is prevented from exceeding the output voltage of the battery after the connection state of the windings has been switched from the second connection state to the first connection state. Thus, the relay can be protected from damage.

In a twelfth aspect according to the eleventh aspect, the second determination unit may determine, as the second mandatory gear shift timing, a timing at which the physical quantity related to the induced voltage becomes less than or equal to a second threshold value corresponding to the output voltage of the battery. As a result, it is possible to use a physical quantity related to the induced voltage to accurately determine the timing after the induced voltage has become less than or equal to the output voltage of the battery.

In a thirteenth aspect according to any one of the first through the twelfth aspects, the winding switching system may further include an input device configured to receive a gear shift instruction from a driver, and the gear shift timing may be a timing at which the input device receives the gear shift instruction from the driver. As a result, the drive motor can execute an electrical gear shift in accordance with a gear shift instruction from the driver.

In a fourteenth aspect according to any one of the first through the twelfth aspects, the gear shift timing may be a timing that is determined based on a rotation speed of the drive motor, the output torque, an acceleration instruction amount of the vehicle, and a braking instruction amount of the vehicle. As a result, the drive motor can execute an electrical gear shift according to timing determined by the rotation speed of the motor, the output torque, the acceleration instruction amount (depression amount of the accelerator pedal), and the braking instruction amount (depression amount of the brake pedal).

In a fifteenth aspect according to any one of the first through the fourteenth aspects, the torque control unit may gradually decrease or gradually increase an effective current of the AC current output from the power converter, starting from the gear shift timing. As a result, the torque can be changed smoothly, and it is possible to provide the driver with a natural gear shift sensation.

In a sixteenth aspect according to the fifteenth aspect, the torque control unit may change the effective current in a ramp shape, starting from the gear shift timing. As a result, it is possible to provide the driver with a gear shift sensation in which torque changes smoothly.

In a seventeenth aspect according to any one of the first through the fourteenth aspects, the torque control unit may change an effective current of the AC current output from the power converter in a stepwise manner based on the gear shift timing. As a result, the driver can be provided with a gear shift sensation in which torque changes suddenly.

In an eighteenth aspect according to any one of the first through the seventeenth aspects, the torque control unit may execute virtual gear shift control processing for decreasing and then increasing the AC current output from the power converter at a virtual gear shift timing different from the gear shift timing. As a result, in addition to the electrical gear shift, the drive motor executes a virtual gear shift. Accordingly, it is possible to provide the driver with a multi stage gear shift sensation.

In a nineteenth aspect, a control device according to the present embodiment is a control device for controlling a drive motor that drives a wheel of a vehicle, including: a torque control unit configured to change an output torque of the drive motor by changing an AC current output from a power converter configured to convert DC power output from a battery into AC power and supply the AC power to the drive motor, at a predetermined gear shift timing of the vehicle; and a switching control unit configured to cause a winding switching device configured to switch a connection state of a plurality of windings in the driving motor to switch from a first connection state to a second connection state after the AC current has changed. As a result, the connection state of the windings of the drive motor is switched from the first connection state to the second connection state, and therefore the performance of the drive motor can be efficiently utilized to realize an electrical gear shift. Furthermore, by changing the output torque of the drive motor in accordance with the switching of the connection state of the windings of the drive motor, it is possible to provide the driver with a gear shift sensation similar to that of a mechanical transmission.

In a twentieth aspect, a control method for a vehicle motor according to the present embodiment is a control method for a vehicle motor, to be executed by a control device for controlling a drive motor that drives a wheel of a vehicle, the control method comprising: a step of changing an output torque of the drive motor by changing an AC current output from a power converter configured to convert DC power output from a battery into AC power and supply the AC power to the drive motor, at a predetermined gear shift timing of the vehicle; and a step of causing a winding switching device configured to switch a connection state of a plurality of windings in the driving motor to switch from a first connection state to a second connection state after the AC current has changed. As a result, the connection state of the windings of the drive motor is switched from the first connection state to the second connection state, and therefore the performance of the drive motor can be efficiently utilized to realize an electrical gear shift. Furthermore, by changing the output torque of the drive motor in accordance with the switching of the connection state of the windings of the drive motor, it is possible to provide the driver with a gear shift sensation similar to that of a mechanical transmission.

In a twenty first aspect, a computer program according to the present embodiment is a computer program to be used by a control device for controlling a drive motor that drives a wheel of a vehicle, the computer program causing a computer to execute: a step of changing an output torque of the drive motor by changing an AC current output from a power converter configured to convert DC power output from a battery into AC power and supply the AC power to the drive motor, at a predetermined gear shift timing of the vehicle; and a step of causing a winding switching device configured to switch a connection state of a plurality of windings in the driving motor to switch from a first connection state to a second connection state after the AC current has changed. As a result, the connection state of the windings of the drive motor is switched from the first connection state to the second connection state, and therefore the performance of the drive motor can be efficiently utilized to realize an electrical gear shift. Furthermore, by changing the output torque of the drive motor in accordance with the switching of the connection state of the windings of the drive motor, it is possible to provide the driver with a gear shift sensation similar to that of a mechanical transmission.

Hereinafter, details of the embodiments of the present disclosure will be described with reference to the drawings. Note that at least some of the embodiments described below may be combined in any manner.

### First Embodiment

### Winding Switching System

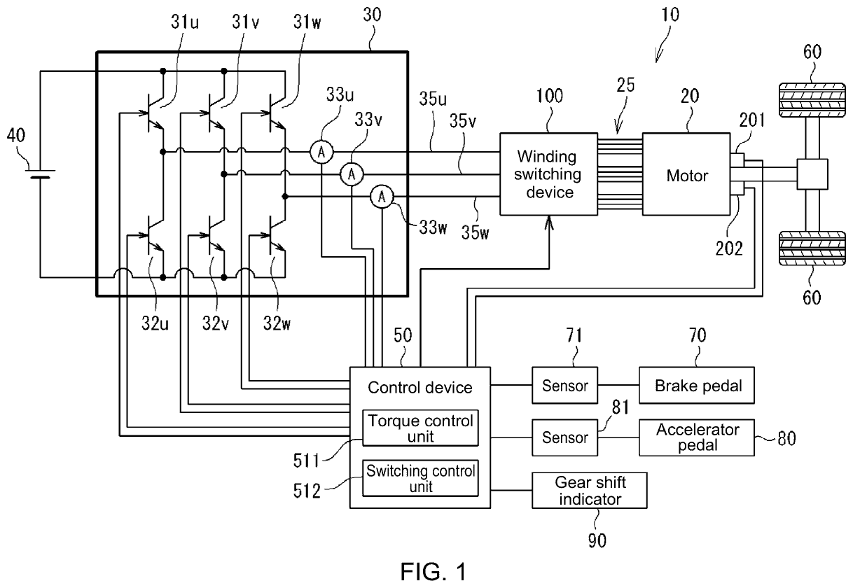

FIG. 1 is a diagram showing an example of a configuration of a winding switching system according to a first embodiment.

The winding switching system 10 is mounted in a vehicle propelled by a motor, such as an electric vehicle or a plug-in hybrid vehicle (hereinafter, referred to as an “electric vehicle”). The winding switching system 10 includes a motor 20, a power converter 30, a battery 40, a control device 50, and a winding switching device 100.

The motor 20 is a travel motor that generates propulsive force for the electric vehicle. That is, the motor 20 is a drive motor that is connected to wheels 60 and drives the wheels 60. The motor 20 is driven by three phase AC power. An example of the motor 20 is a permanent magnet synchronous motor.

The battery 40 is a battery for supplying power to drive the motor 20. The battery 40 is a secondary battery, and is, for example, a lithium ion battery.

The power converter 30 is an inverter that converts DC power supplied from the battery 40 into three-phase AC power. The power converter 30 may have a function of converting the three phase AC power output when the motor 20 functions as a generator into DC power and charging the battery 40.

The power converter 30 includes a leg for each of the U-phase, the V-phase, and the W-phase. The U-phase leg includes switches 31u and 32u, the V-phase leg includes switches 31v and 32v, and the W-phase leg includes switches 31w and 32w. The switches 31u, 32u, 31v, 32v, 31w, and 32w perform switching, whereby the DC power is converted into three phase AC power. The switches 31u, 32u, 31v, 32v, 31w, and 32w are, for example, insulated gate bipolar transistors (IGBTs) or power metal oxide semiconductor field-effect transistors (MOSFETs).

A power line 35u corresponding to the U-phase extends from the U-phase leg, a power line 35v corresponding to the V-phase extends from the V-phase leg, and a power line 35w corresponding to the W-phase extends from the W-phase leg. In the power converter 30, a current sensor 33u is provided on the power line 35u, a current sensor 38v is provided on the power line 35v, and a current sensor 33w is provided on the power line 35w. The current sensor 33u detects the current value of the U-phase current Iu. The current sensor 33v detects the current value of the V-phase current Iv. The current sensor 33w detects the current value of the W-phase current Iw. The current sensors 33u, 33v, and 33w can detect the current values as well as the DC and AC components of the currents Iu, Iv, and Iw flowing through the power lines 35u, 35v, and 35w. The current sensors 33u, 33v, and 33w are, for example, DC current transformers (DCCTs) or shunt resistors.

The winding switching device 100 is disposed between the motor 20 and the power converter 30. However, the location of the winding switching device 100 is not limited to between the motor 20 and the power converter 30. The power converter 30 and the winding switching device 100 are connected to each other by the power lines 35u, 35v, and 35w, and the winding switching device 100 and the motor 20 are connected to each other by a plurality of power lines 25. The winding switching device 100 switches the connection state of a plurality of windings of the motor 20. The configuration of the winding switching device 100 will be described later. Three-phase AC currents Iu, Iv, and Iw output from the power converter 30 are supplied to the motor 20 via the winding switching device 100.

The control device 50 controls the motor 20. Specifically, the control device 50 controls the motor 20 by controlling the power converter 30 and the winding switching device 100. Signal lines extend from the control device 50 to each of the switches 31u, 32u, 31v, 32v, 31w, and 32w, and the control device 50 controls the on/off timing of the switches 31u, 32u, 31v, 32v, 31w, and 32w. A signal line extends from the control device 50 to the winding switching device 100, and the control device 50 outputs a switching command signal for commanding switching of the connection state of the windings to the winding switching device 100.

The control device 50 is connected to a sensor 71 that detects a depression amount of a brake pedal 70, and receives a detection signal output from the sensor 71. The control device 50 is connected to a sensor 81 that detects a depression amount of an accelerator pedal 80, and receives a detection signal output from the sensor 81.

A rotation sensor 201 for detecting the rotation speed of the motor 20 and a torque sensor 202 for detecting the output torque of the motor 20 are attached to an output shaft of the motor 20. The rotation sensor 201 and the torque sensor 202 are connected to the control device 50. The control device 50 receives a detection signal output from the rotation sensor 201 and a detection signal output from the torque sensor 202.

The control device 50 is connected to a gear shift indicator 90. The gear shift indicator 90 is an input device that allows the driver to input a gear shift instruction. The gear shift indicator 90 is, for example, a shift lever. In another example, the gear shift indicator 90 is a switch that allows the driver to instruct upshifting or downshifting, The gear shift indicator 90 outputs a gear shift instruction signal in response to an operation by the driver. The control device 50 receives a gear shift instruction signal output from the gear shift indicator 90.

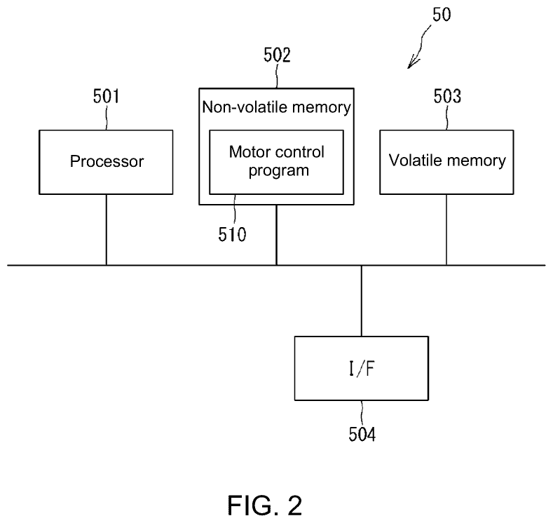

FIG. 2 is a block diagram illustrating an example of a hardware configuration of the control device. The control device 50 includes a processor 501, a non-volatile memory 502, a volatile memory 503, and an interface (I/F) 504.

The volatile memory 503 is a semiconductor memory such as a static random access memory (SRAM) or a dynamic random access memory (DRAM). The non-volatile memory 502 is, for example, a flash memory, a hard disk, a read only memory (ROM), or the like. The non-volatile memory 502 stores a motor control program 510, which is a computer program, and data used to execute the motor control program 510. Each function of the control device 50 is realized by the processor 501 executing the motor control program 510. The motor control program 510 can be stored in a recording medium such as a flash memory, a ROM, or a CD-ROM. The processor 501 controls the power converter 30 and the winding switching device 100 according to the motor control program 510.

The processor 501 is, for example, a central processing unit (CPU). However, the processor 501 is not limited to a CPU. The processor 501 may also be a graphics processing unit (GPU). The processor 501 is, for example, a multi-core processor, The processor 501 may also be a single core processor. The processor 501 may also be, for example, an application specific integrated circuit (ASIC), or a programmable logic device such as a gate array or a field programmable gate array (FPGA). In this case, the ASIC or programmable logic device is configured to be able to execute the same processing as the motor control program 510.

The I/F 504 is connected to the rotation sensor 201, the torque sensor 202, the sensor 71, the sensor 81, and the gear shift indicator 90. The I/F 504 is, for example, an input/output interface or a communication interface. The I/F 504 receives a detection signal of the rotation speed of the motor 20 output from the rotation sensor 201. The I/F 504 receives a detection signal of the output torque of the motor 20 output from the torque sensor 202. The I/F 504 receives a detection signal of the depression amount of the brake pedal output from the sensor 71. The I/F 504 receives a detection signal of the depression amount of the accelerator pedal output from the sensor 81. The I/F 504 receives a gear shift instruction signal output from the gear shift indicator 90.

### Configuration of Winding Switching Device

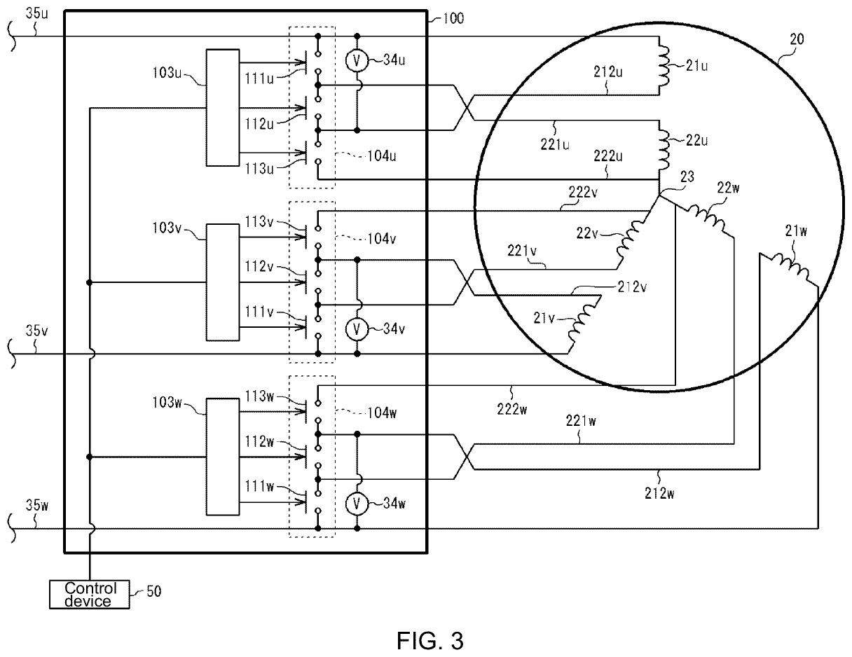

FIG. 3 is a circuit diagram showing an example of the configuration of the winding switching device according to the first embodiment. The motor 20 includes a plurality of windings 21u, 22u, 21v, 22v, 21w, and 22w. The windings 21u and 22u correspond to the U-phase, the windings 21v and 22v correspond to the V-phase, and the windings 21w and 22w correspond to the W-phase. However, the number of windings for each phase is not limited to two, and may be three or more. The windings 22u, 22v, and 22w are connected at a neutral point 23.

The winding switching device 100 switches the connection state of the windings 21u, 22u, 21v, 22v, 21w, and 22w for each phase between a series connection state and a parallel connection state. The winding switching device 100 includes control circuits 103u, 103v, and 103w and switching circuits 104u, 104v, and 104w.

The switching circuits 104u, 104v, and 104w switch the connection state of the windings 21u, 22u, 21v, 22v, 21w, and 22w between a series connection state and a parallel connection state in accordance with control from the control device 50. The series connection state is an example of a first connection state, and the parallel connection state is an example of a second connection state.

Hereinafter, the connection relationship between the winding switching device 100, the power line 35u, and the motor 20 will be described for the U-phase as a representative example. Since the same applies for the V-phase and the W-phase, description thereof is omitted.

The power line 35uis connected to one end of the winding 21u. A power line 212u extends from the other end of the winding 21u. A power line 221u extends from one end of the winding 22u, and a power line 222u extends from the other end.

The switching circuit 104u includes semiconductor relays 111u, 112u, and 113u. The semiconductor relays 111u, 112u, and 113u are, for example, IGBTs or power MOSFETs.

The power line 35u is led into the winding switching device 100. In the winding switching device 100, the power line 35ubranches off at an intermediate point and is connected to a first terminal of the semiconductor relay 111u. A second terminal of the semiconductor relay 111u is connected to a first terminal of the semiconductor relay 112u. The power line 221u extending from the winding 22u is connected to a connection point between the second terminal of the semiconductor relay 11u and the first terminal of the semiconductor relay 112u. The power lines 212u, 221u, and 222u extend from the motor 20 and are led into the winding switching device 100.

A second terminal of the semiconductor relay 112u is connected to a first terminal of the semiconductor relay 113u. The power line 212u extending from the winding 21u is connected to a connection point between the second terminal of the semiconductor relay 112u and the first terminal of the semiconductor relay 113u. A second terminal of the semiconductor relay 113u is connected to the power line 222uextending from the winding 22u.

When the semiconductor relays 111u and 113u are in an off state and the semiconductor relay 112u is in an on state, the windings 21u and 22u are connected in series. When the semiconductor relays 111u and 113u are in an on state and the semiconductor relay 112u is in an off state, the windings 21u and 22u are connected in parallel.

Signal lines extending from the control circuit 103u are respectively connected to the gate terminals of the semiconductor relays 111u, 112u, and 113u. A signal line extending from the control device 50 is connected to the control circuit 103u.

The control circuit 103u applies a gate voltage to the gate terminals of the semiconductor relays 111u, 112u, and 113u individually, thereby controlling the switching on/off of the semiconductor relays 111u, 112u, and 113u. Specifically, if the control circuit 103u receives an instruction from the control device 50 to switch the connection state of the windings 21u and 22u from a series connection state to a parallel connection state, the control circuit 103u sets the semiconductor relays 111u and 113u to the on state and sets the semiconductor relay 112u to the off state. If the control circuit 103u receives an instruction from the control device 50 to switch the connection state of the windings 21u and 22u from a parallel connection state to a series connection state, the control circuit 103u sets the semiconductor relays 111u and 113u to the off state and sets the semiconductor relay 112u to the on state.

The control circuit 103u is constituted by, for example, a plurality of logic circuits (AND circuits, NOT circuits, latch circuits, etc.). In another example, the control circuit 103u is constituted by a processor. For example, the control circuit 103u is constituted by a one-chip microcomputer. The control circuit 103u may also be constituted by a programmable logic device such as an ASIC or an FPGA.

### Functions of Control Device

Returning to FIG. 1, the functions of the control device 50 will be described. The control device 50 has the functions of a torque control unit 511 and a switching control unit 512. The functions of the torque control unit 511 and the switching control unit 512 are realized by the processor 501 executing the motor control program 510.

The torque control unit 511 changes the output torque of the motor 20 by changing AC current output from the power converter 30 at a predetermined gear shift timing of the electric vehicle. The switching control unit 512 causes the winding switching device 100 to switch the connection state of the windings 21u, 22u, 21v, 22v, 21w, and 22w of the motor 20 after the AC current output from the power converter 30 has changed.

The gear shift timing is, for example, the timing at which the control device 50 receives a gear shift instruction output from the gear shift indicator 90. That is, in the vehicle including the gear shift indicator 90, if the driver uses the gear shift indicator 90 to instruct a gear shift, the control device 50 changes the AC current output from the power converter 30, starting from the timing when the gear shift instruction is input to the control device 50.

In another example, the gear shift timing is a timing determined based on the rotation speed of the motor 20, the output torque of the motor 20, the depression amount of the brake pedal 70 (braking instruction amount), and the depression amount of the accelerator pedal 80 (acceleration instruction amount). That is, an automatic gear shift control device (not shown) in the vehicle generates a gear shift instruction based on the rotation speed of the motor 20, the output torque of the motor 20, the depression amount of the brake pedal 70 (braking instruction amount), and the depression amount of the accelerator pedal 80 (acceleration instruction amount), and the generated gear shift instruction is input to the control device 50. Regarding the gear shift timing, if a gear shift instruction generated by such an automatic gear shift control device is input to the control device 50, the control device 50 changes the AC current output from the power converter 30 at the timing when the gear shift instruction is input to the control device 50.

When the windings 21u, 22u, 21v, 22v, 21w, and 22w of the motor 20 are connected in series, the motor 20 can output high torque. When the windings 21u, 22u, 21v, 22v, 21w, and 22w of the motor 20 are connected in parallel, the output torque of the motor 20 decreases compared to when they are connected in series at the same rotation speed. That is, when the windings 21u, 22u, 21v, 22v, 21w, and 22w are in a series connection state, the motor 20 is in a low rotation, high-torque state, and when the windings 21u, 22u, 21v, 22v, 21w, and 22w are in a parallel connection state, the motor 20 is in a high-rotation, low torque state. Switching the connection state of the windings 21u, 22u, 21v, 22v, 21w, and 22w of the motor 20 from a series connection state to a parallel connection state corresponds to upshifting in a mechanical transmission, and switching the connection state of the windings 21u, 22u, 21v, 22v, 21w, and 22w of the motor 20 from a parallel connection state to a series connection state corresponds to downshifting in a mechanical transmission. Switching the connection state of the windings 21u, 22u, 21v, 22v, 21w, and 22w of the motor 20 from a series connection state to a parallel connection state is also referred to as “electrical upshifting”, and switching the connection state of the windings 21u, 22u, 21v, 22v, 21w, and 22w of the motor 20 from a parallel connection state to a series connection state is also referred to as “electrical downshifting”.

For example, the torque control unit 511 reduces the output torque of the motor 20 by reducing the AC current output from the power converter 30 at a first gear shift timing. After the AC current output from the power converter 30 has decreased to a first target value or less, the switching control unit 512 causes the winding switching device 100 to switch the connection state of the windings 21u, 22u, 21v, 22v, 21w, and 22w of the motor 20 from a series connection state to a parallel connection state. The first gear shift timing is the timing when electrical upshifting is instructed.

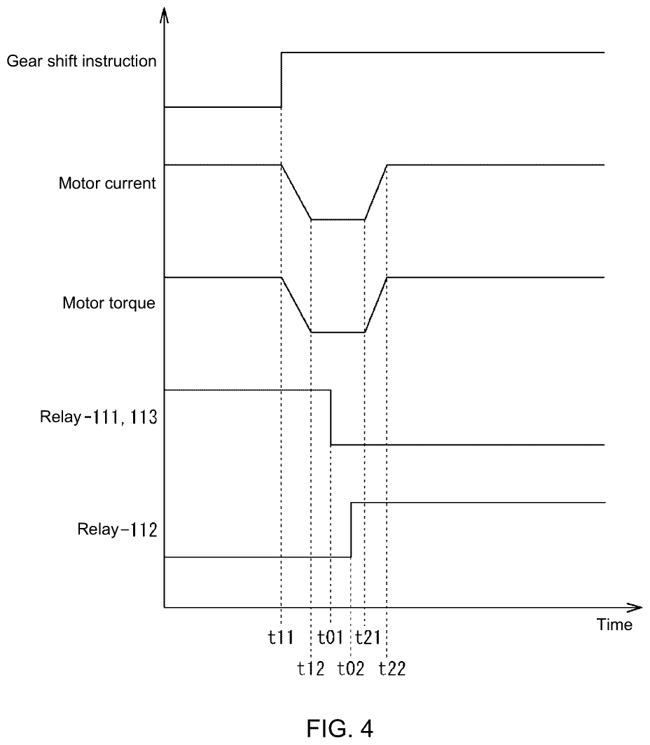

FIG. 4 is a timing chart showing an example of switching timing of the windings 21u, 22u, 21v, 22v, 21w, and 22w of the motor 20 in the winding switching system according to the first embodiment. FIG. 4 shows an example of timing of a gear shift instruction, the current supplied to the motor 20 (hereinafter also referred to as “motor current”), the output torque of the motor 20 (hereinafter also referred to as “motor torque”), and the switching on/off of the semiconductor relays 111u, 112u, 113u, 111v, 112v, 113v, 111w, 112w, and 113w when the connection state of the windings 21u, 22u, 21v, 22v, 21w, and 22w of the motor 20 is switched from a series connection state to a parallel connection state. Note that in the following, the semiconductor relays 111u, 111v, and 111w are collectively referred to as “relay 111”, the semiconductor relays 112u, 112v, and 112w are collectively referred to as “relay 112”, and the semiconductor relays 113u, 113v, and 113w are collectively referred to as “relay 113”.

At time t11, a gear shift instruction (electrical downshift instruction) is input to the control device 50. The torque control unit 511 reduces a motor current Iq, starting from time t11. The motor current Iq is the effective current (Q-axis current) of the AC current applied to the motor 20. In the example shown in FIG. 4, the motor current Iq gradually decreases in a ramp shape. As the motor current Iq decreases, the motor torque also decreases.

At time t12, the motor current Iq reaches a first target value Th1. The torque control unit 511 stops the decrease of the motor current Iq at time t12 when the motor current Iq reaches the first target value Th1. That is, at time t12 and onward, the motor current Iq is maintained at the first target value Th1. At or after time t12, the decrease of the motor torque also stops.

At a timing at or after time t12, the switching control unit 512 switches the connection state of the windings 21u, 22u, 21v, 22v, 21w, and 22w from a series connection state to a parallel connection state. In the example of FIG. 4, at time t01, which is after time t12, the relays 111 and 113 are switched from the on state to the off state, and at time t02, which is after time t01, the relay 112 is switched from the off state to the on state. In the period of time between time t01 and time t02, all of the relays 111, 112, and 113 are in the off state. This prevents all of the relays 111, 112, and 113 from being turned on when the connection state of the windings 21u, 22u, 21v, 22v, 21w, and 22w is switched.

Starting from time t21, which is after time t02, the torque control unit 511 increases the motor current Iq. At this time, the target value of the motor current Ig is determined based on the target torque when the windings 21u, 22u, 21v, 22v, 21w, and 22w are in the parallel connection state. The target torque is determined based on the rotation speed of the motor 20, the output torque of the motor 20, the depression amount of the brake pedal 70 (brake instruction amount), and the depression amount of the accelerator pedal 80 (acceleration instruction amount). In the example shown in FIG. 4, the motor current Iq increases in a ramp shape. As the motor current Iq increases, the motor torque also increases.

At time t22, the motor current Iq reaches the above described target value. The torque control unit 511 stops the increase of the motor current Iq at time t22 when the motor current Iq reaches the target value. After time t22, the increase of the motor torque also stops.

As described above, the connection state of the windings 21u, 22u, 21v, 22v, 21w, and 22w of the motor 20 is switched from a series connection state to a parallel connection state, and therefore the performance of the motor 20 can be efficiently utilized to electrically perform a gear shift from a low-rotation, high-torque state to a high-rotation, low torque state. Furthermore, since the output torque of the motor 20 decreases accompanying the switching of the connection state of the windings 21u, 22u, 21v, 22v, 21w, and 22w of the motor 20, it is possible to provide the driver with a gear shift sensation similar to that of a mechanical transmission.

The first target value Th1 is, for example, 0 A. If the connection state is switched while current is flowing through the windings 21u, 22u, 21v, 22v, 21w, and 22w, a torque shock occurs due to a sudden change in the current through the windings 21u, 22u, 21v, 22v, 21w, and 22w, which are inductive loads. Furthermore, the relays 111, 112, and 113 will be damaged by a surge. By setting the first target value Th1 to 0 A, damage to the relays 111, 112, and 113 due to the torque shock and surge described above can be suppressed.

For example, when electrical downshifting is instructed while the rotation speed of the motor 20 is increasing, that is, while the vehicle is accelerating, the torque control unit 511 reduces the output torque of the motor 20 by reducing the AC current output from the power converter 30 at a second gear shift timing. After the AC current output from the power converter 30 has decreased to the first target value or less, the switching control unit 512 causes the winding switching device 100 to switch the connection state of the windings 21u, 22u, 21v, 22v, 21w, and 22w of the motor 20 from a parallel connection state to a series connection state. The second gear shift timing is the timing when electrical downshifting is instructed.

Since the connection state of the windings 21u, 22u, 21v, 22v, 21w, and 22w of the motor 20 is switched from a parallel connection state to a series connection state, the performance of the motor 20 can be efficiently utilized to electrically perform a gear shift from a high rotation, low torque state to a low-rotation, high torque state. Furthermore, since the output torque of the motor 20 increases accompanying the switching of the connection state of the windings 21u, 22u, 21v, 22v, 21w, and 22w of the motor 20, it is possible to provide the driver with a gear shift sensation similar to that of a mechanical transmission.

For example, when electrical downshifting is instructed while the motor 20 is performing regenerative braking, the torque control unit 511 increases the output torque of the motor 20 by increasing the AC current output from the power converter 30 at the second gear shift timing. During regenerative braking, torque for braking the vehicle, that is, negative torque, is generated, and the braking force decreases due to the output torque of the motor 20 increasing (approaching zero). After the AC current output from the power converter 30 has increased to a second target value or more, the switching control unit 512 causes the winding switching device 100 to switch the connection state of the windings 21u, 22u, 21v, 22v, 21w, and 22w of the motor 20 from a parallel connection state to a series connection state.

As described above, the connection state of the windings 21u, 22u, 21v, 22v, 21w, and 22w of the motor 20 is switched from a parallel connection state to a series connection state, and therefore the performance of the motor 20 can be efficiently utilized to electrically perform a gear shift from a high-rotation, low-torque state to a low rotation, high torque state. The amount of regeneration by the motor 20 is higher in a low-rotation, high torque state than in a high-rotation, low-torque state. Accordingly, the regenerative braking force can be increased through electrical downshifting, and the driver can be provided with a deceleration sensation similar to that of engine braking. Furthermore, since the negative output torque of the motor 20 decreases (the absolute value of the output torque increases) accompanying the switching of the connection state of windings 21u, 22u, 21v, 22v, 21w, and 22w of the motor 20, the driver can be provided with a gear shift sensation similar to that of a mechanical transmission.

The torque control unit 511 can gradually increase the motor current Ig in a ramp shape during electrical downshifting. Due to the motor current Iq gradually decreasing in a ramp shape during electrical upshifting, and the motor current Iq gradually increasing in a ramp shape during electrical downshifting, the driver can be provided with a natural gear shift sensation.

The second target value Th2 is, for example, 0 A. This makes it possible to suppress damage to the relays 111, 112, and 113 due to a torque shock and a surge caused by a sudden change in current in the windings 21u, 22u, 21v, 22v, 21w, and 22w.

For example, when electrical upshifting is instructed while the motor 20 is performing regenerative braking, the torque control unit 511 increases the output torque of the motor 20 by increasing the AC current output from the power converter 30 at the first gear shift timing. After the AC current output from the power converter 30 has increased to the second target value or more, the switching control unit 512 causes the winding switching device 100 to switch the connection state of the windings 21u, 22u, 21v, 22v, 21w, and 22w of the motor 20 from a series connection state to a parallel connection state.

Since the connection state of the windings 21u, 22u, 21v, 22v, 21w, and 22w of the motor 20 is switched from a series connection state to a parallel connection state, the performance of the motor 20 can be efficiently utilized to electrically perform a gear shift from a low rotation, high torque state to a high-rotation, low torque state. Due to the electrical upshifting, the regenerative braking force can be reduced, and it is possible to provide the driver with a deceleration sensation similar to that of engine braking. Furthermore, since the negative output torque of the motor 20 increases (the absolute value of the output torque decreases) accompanying the switching of the connection state of the windings 21u, 22u, 21v, 22v, 21w, and 22w of the motor 20, it is possible to provide the driver with a gear shift sensation similar to that of a mechanical transmission.

### Operation of Winding Switching System

Next, the operation of the winding switching device 100 will be described. The control device 50 executes electrical upshifting processing and electrical downshifting processing by the processor 501 executing the motor control program 510.

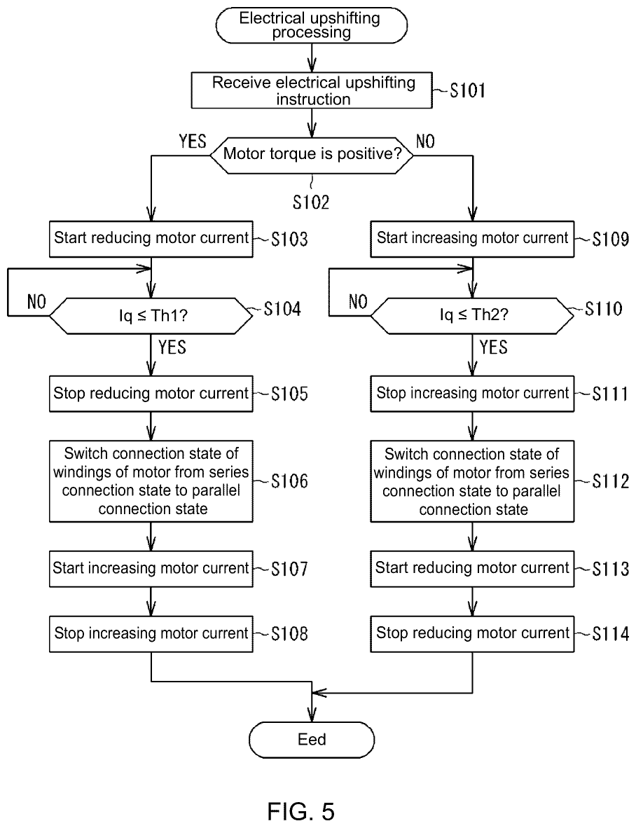

FIG. 5 is a flowchart showing an example of electrical upshifting processing performed by the control device according to the first embodiment. In this example, it is assumed that the windings 21u, 22u, 21v, 22v, 21w, and 22w of the motor 20 are in a series connection at the start of the electrical upshifting processing.

When the driver performs electrical upshifting of the vehicle, the driver operates the gear shift indicator 90 to input an electrical upshifting instruction to the vehicle. The processor 501 receives an electrical upshifting instruction (step S101).

The processor 501 refers to the detection signal of the torque sensor 202 and judges whether or not the motor torque is positive, that is, whether or not the motor 20 is generating torque for accelerating the vehicle or maintaining the speed of the vehicle (hereinafter referred to as “acceleration torque”) (step S102).

If the motor torque is positive (YES in step S102), the processor 501 outputs an instruction to the power converter 30 to decrease the motor current Iq (step S103). This causes the motor current Iq to start decreasing.

The processor 501 acquires the current value of the motor current Iq from the detection signals of the current sensors 33u, 33v, and 33w, and judges whether or not the motor current Iq is less than or equal to the first target value Th1 (step S104).

If the motor current Iq is greater than the first target value Th1 (NO in step S104), the processor 501 executes step S104 again. If motor current Iq is less than or equal to the first target value Th1 (YES in step S104), the processor 501 outputs an instruction to the power converter 30 to stop the decrease of the motor current Iq (step S105). This causes the motor current Iq to stop decreasing.

The processor 501 outputs an instruction to the winding switching device 100 to switch the connection state of the windings 21u, 22u, 21v, 22v, 21w, and 22w of the motor 20 from a series connection state to a parallel connection state (step S106). As a result, while the motor current Iq is less than or equal to the first target value Th1, the connection state of the windings 21u, 22u, 21v, 22v, 21w, and 22w is switched from a series connection state to a parallel connection state, and electrical upshifting is performed.

After outputting an instruction to switch the connection states of the windings 21u, 22u, 21v, 22v, 21w, and 22w of the motor 20, the processor 501 outputs an instruction to the power converter 30 to increase the motor current Iq (step S107). This causes the motor current Iq to start increasing.

If the motor current reaches a target value determined based on the target torque when the windings 21u, 22u, 21v, 22v, 21w, and 22w are in the parallel connection state, the processor 501 outputs an instruction to the power converter 30 to stop increasing the motor current Iq (step S108). This causes the motor current Iq to stop increasing. This ends the electrical upshifting processing performed when the motor torque is positive.

If the motor torque is negative (NO in step S102), the motor 20 is performing regenerative braking. The power converter 30 functions as a DC/AC converter, and converts the AC current output from the motor 20 into a DC current. The converted DC current is output to and stored in the battery 40. In this case, the processor 501 outputs an instruction to the power converter 30 to increase the motor current Iq (step S109). This causes the motor current Iq to start increasing.

The processor 501 acquires the current value of the motor current Iq from the detection signals of the current sensors 33u, 33v, and 33w, and judges whether or not the motor current Iq is greater than or equal to the second target value Th2 (step S110).

If the motor current Iq is smaller than the second target value Th2 (NO in step S110), the processor 501 executes step S110 again. If the motor current Iq is greater than or equal to the second target value Th2 (YES in step S110), the processor 501 outputs an instruction to the power converter 30 to stop increasing the motor current Iq (step S111). This causes the motor current Iq to stop increasing.

The processor 501 outputs an instruction to the winding switching device 100 to switch the connection state of the windings 21u, 22u, 21v, 22v, 21w, and 22w of the motor 20 from a series connection state to a parallel connection state (step S112). As a result, while the motor current Iq is greater than or equal to the second target value Th2, the connection state of the windings 21u, 22u, 21v, 22v, 21w, and 22w is switched from a series connection state to a parallel connection state, and electrical upshifting is performed.

After outputting an instruction to switch the connection state of the windings 21u, 22u, 21v, 22v, 21w, and 22w of the motor 20, the processor 501 outputs an instruction to the power converter 30 to reduce the motor current Iq (step S112). This causes the motor current Iq to start decreasing.

If the motor current reaches a target value determined based on the target torque when the windings 21u, 22u, 21v, 22v, 21w, and 22w are in the parallel connection state, the processor 501 outputs an instruction to the power converter 30 to stop the decrease of the motor current Iq (step S113). This causes the motor current Iq to stop decreasing. This is the end of the electrical upshifting processing performed when the motor torque is negative.

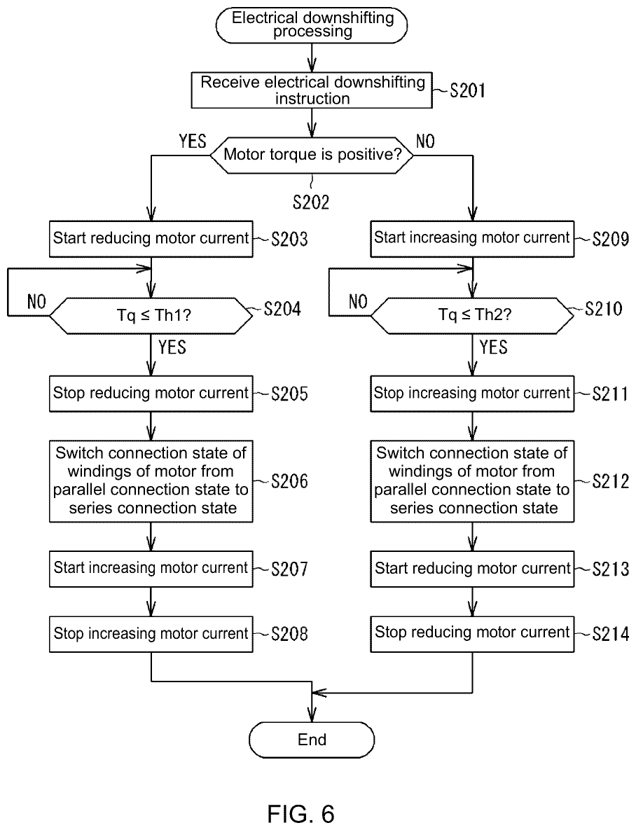

FIG. 6 is a flowchart showing an example of electrical downshifting processing performed by the control device according to the first embodiment. In this example, it is assumed that the windings 21u, 22u, 21v, 22v, 21w, and 22w of the motor 20 are connected in parallel at the start of the electrical downshifting processing.

When the driver performs electrical downshifting of the vehicle, the driver operates the gear shift indicator 90 to input an electrical downshifting instruction to the vehicle. The processor 501 receives the electrical downshifting instruction (step S201).

The processor 501 refers to the detection signal of the torque sensor 202 and judges whether or not the motor torque is positive, that is, whether or not the motor 20 is generating an acceleration torque (step S202).

If the motor torque is positive (YES in step S202), the processor 501 outputs an instruction to the power converter 30 to decrease the motor current Iq (step S203). This causes the motor current Iq to start decreasing.

The processor 501 acquires the current value of the motor current Iq from the detection signals of the current sensors 33u, 33v, and 33w, and judges whether or not the motor current Iq is less than or equal to the first target value Th1 (step S204).

If the motor current Iq is greater than the first target value Th1 (NO in step S204), the processor 501 executes step S204 again. If the motor current Iq is less than or equal to the first target value Th1 (YES in step S204), the processor 501 outputs an instruction to the power converter 30 to stop the decrease of the motor current Iq (step S205). This causes the motor current Iq to stop decreasing.

The processor 501 outputs an instruction to the winding switching device 100 to switch the connection state of the windings 21u, 22u, 21v, 22v, 21w, and 22w of the motor 20 from a parallel connection state to a series connection state (step S206). As a result, while the motor current Iq is less than or equal to the first target value Th1, the connection state of the windings 21u, 22u, 21v, 22v, 21w, and 22w is switched from a parallel connection state to a series connection state, and electrical downshifting is performed.

After outputting an instruction to switch the connection state of the windings 21u, 22u, 21v, 22v, 21w, and 22w of the motor 20, the processor 501 outputs an instruction to the power converter 30 to increase the motor current Iq (step S207). This causes the motor current Iq to start increasing.

If the motor current reaches a target value determined based on the target torque when the windings 21u, 22u, 21v, 22v, 21w, and 22w are in the parallel connection state, the processor 501 outputs an instruction to the power converter 30 to stop increasing the motor current Iq (step S208). This causes the motor current Iq to stop increasing. This completes the electrical downshifting processing performed when the motor torque is positive.

If the motor torque is negative (NO in step S202), the motor 20 is performing regenerative braking. In this case, the processor 501 outputs an instruction to the power converter 30 to increase the motor current Iq (step S209). This causes the motor current Iq to start increasing.

The processor 501 acquires the current value of the motor current Iq from the detection signals of the current sensors 33u, 33v, and 33w, and judges whether or not the motor current Iq is greater than or equal to the second target value Th2 (step S210).

If the motor current Iq is less than the second target value Th2 (NO in step S210), the processor 501 executes step S210 again. If the motor current Iq is greater than or equal to the second target value Th2 (YES in step S210), the processor 501 outputs an instruction to the power converter 30 to stop increasing the motor current Iq (step S211). This causes the motor current Iq to stop increasing.

The processor 501 outputs an instruction to the winding switching device 100 to switch the connection state of the windings 21u, 22u, 21v, 22v, 21w, and 22w of the motor 20 from a parallel connection state to a series connection state (step S212). As a result, while the motor current Iq is greater than or equal to the second target value Th2, the connection state of the windings 21u, 22u, 21v, 22v, 21w, and 22w is switched from a parallel connection state to a series connection state, and electrical downshifting is performed.

After outputting an instruction to switch the connection state of the windings 21u, 22u, 21v, 22v, 21w, and 22w of the motor 20, the processor 501 outputs an instruction to decrease the motor current Iq to the power converter 30 (step S212). This causes the motor current Iq to start decreasing.

If the motor current reaches a target value determined based on the target torque when the windings 21u, 22u, 21v, 22v, 21w, and 22w are in the parallel connection state, the processor 501 outputs an instruction to the power converter 30 to stop the reduction of the motor current Iq (step S213). This causes the motor current Iq to stop decreasing. This completes the electrical downshifting processing performed when the motor torque is negative.

### Second Embodiment

The winding switching device of the second embodiment switches the connection state of a plurality of windings of a motor between a full connection state in which all of the plurality of windings are connected, and a partial connection state in which some of the plurality of windings are connected.

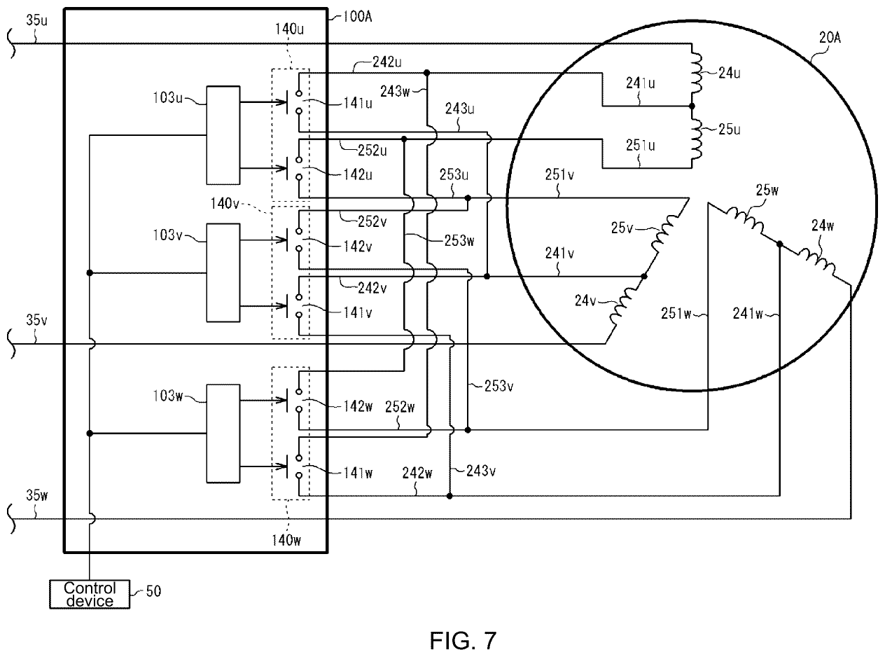

FIG. 7 is a circuit diagram showing an example of a configuration of a winding switching device according to a second embodiment. A motor 20A includes a plurality of windings 24u, 25u, 24v, 25v, 24w, and 25w. The windings 24u and 25u correspond to a U-phase, the windings 24v and 25v correspond to a V-phase, and the windings 24w and 25w correspond to a W-phase. However, the number of windings for each phase is not limited to two, and may be three or more.

A winding switching device 100A switches the connection state of the windings 24u, 25u, 24v, 25v, 24w, and 25w for each phase between a full connection state and a partial connection state. The winding switching device 100A includes control circuits 103u, 103v, and 103w and switching circuits 140u, 140v, and 140w.

The switching circuits 140u, 140v, 140w switch the connection state of the windings 24u, 25u, 24v, 25v, 24w, 25w between the full connection state and the partial connection state. The full connection state is an example of a first connection state, and the partial connection state is an example of a second connected state.

A power line 35u is connected to one end of the winding 24u. The other end of the winding 24u and one end of the winding 25u are connected to each other, and a power line 24u extends from an intermediate point between the windings 24u and 25u. The power line 241u branches into power lines 242u and 243w. A power line 251u extends from the other end of the winding 25u. The power line 251u branches into power lines 252u and 258w.

A power line 35v is connected to one end of the winding 24v. The other end of the winding 24v and the one end of the winding 25v are connected to each other, and a power line 241v extends from an intermediate point between the windings 24v and 25v. The power line 241v branches into power lines 242v and 248u. A power line 251v extends from the other end of the winding 25v. The power line 251v branches into power lines 252v and 253u.

A power line 35w is connected to one end of the winding 24w. The other end of the winding 24w and one end of the winding 25w are connected to each other, and a power line 241w extends from an intermediate point between the windings 24w and 25w. The power line 241w branches into power lines 242w and 243v. A power line 251w extends from the other end of the winding 25w. The power line 251w branches into power lines 252w and 253v.

The switching circuit 140u includes semiconductor relays 141u and 142u. The switching circuit 140v includes semiconductor relays 141v and 142v. The switching circuit 140w includes semiconductor relays 141w and 142w. The semiconductor relays 141u, 142u, 141v, 142v, 141w, and 142w are, for example, IGBTs or power MOSFETs.

In the switching circuit 140u, a first terminal of the semiconductor relay 141u is connected to the power line 242u, and a second terminal of the semiconductor relay 141u is connected to the power line 243u. A first terminal of the semiconductor relay 142u is connected to the power line 252u, and a second terminal of the semiconductor relay 142u is connected to the power line 253u. The connection relationships of the switching circuits 140v and 140w are similar to that of the switching circuit 140u, and therefore description thereof is omitted.

When the semiconductor relays 141u, 141v, and 141w are in the off state and the semiconductor relays 142u, 142v, and 142w are in the on state, the full connection state is entered in which all of the windings 24u, 25u, 24v, 25v, 24w, and 25w are connected. When the semiconductor relays 141u, 141v, and 141w are in the on state and the semiconductor relays 142u, 142v, and 142w are in the off state, the partial connection state is entered in which only the windings 24u, 24v, and 24w are connected among the windings 24u, 25u, 24v, 25v, 24w, and 25w.

Other configurations of the winding switching device 100A according to the second embodiment are similar to those of the winding switching device 100 according to the first embodiment, and therefore identical components are denoted by identical reference numerals and description thereof is omitted.

In the second embodiment, electrical upshifting is performed by switching the connection state of the windings 24u, 25u, 24v, 25v, 24w, and 25w of the motor 20 from a full connection state to a partial connection state. Electrical downshifting is performed by switching the connection state of the windings 24u, 25u, 24v, 25v, 24w, and 25w of the motor 20 from a partial connection state to a full connection state.

### Third Embodiment

In the third embodiment, the torque control unit 511 changes the effective current of the AC current output from the power converter 30 in a stepwise manner based on the gear shift timing.

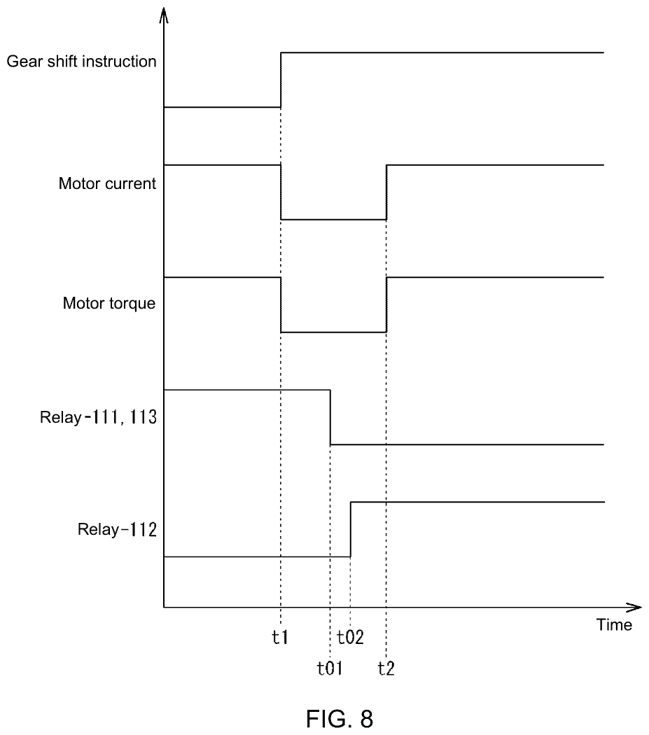

FIG. 8 is a timing chart showing an example of switching timing of the windings 21u, 22u, 21v, 22v, 21w, and 22w of the motor 20 in the winding switching system according to the third embodiment. Note that since the configuration of the winding switching system according to the third embodiment is the same as the configuration of the winding switching system 10 according to the first embodiment, identical components are denoted by identical reference numerals and description thereof is omitted.

FIG. 8 shows an example of the timing of the gear shift instruction, the motor current, the motor torque, and the switching on/off of the semiconductor relays 111, 112, and 113 when the connection state of the windings 21u, 22u, 21v, 22v, 21w, and 22w of the motor 20 is switched from a series connection state to a parallel connection state.

A gear shift instruction (electrical upifting instruction) is input to the control device 50 at time t1. At time t1, the torque control unit 511 reduces the motor current Iq in a stepwise manner to the first target value Th1 or less. Accompanying the decrease of the motor current Iq, the motor torque also decreases in a step-like manner. After time t1, the motor current Iq is maintained at the first target value Th1.

At a timing at or after time t1, the switching control unit 512 switches the connection state of the windings 21u, 22u, 21v, 22v, 21w, and 22w from a series connection state to a parallel connection state. In the example of FIG. 8, at time t01, which is after time t1, the relays 111 and 113 are switched from the on state to the off state, and at time t02, which is after time t01, the relay 112 is switched from the off state to the on state. In the period of time between time t01 and time t02, all of the relays 111, 112, and 113 are in the off state. This prevents all of the relays 111, 112, and 113 from being turned on when the connection state of the windings 21u, 22u, 21v, 22v, 21w, and 22w is switched.

At time t2, which is after time t02, the torque control unit 511 increases the motor current Iq in a stepwise manner, At this time, the target value of the motor current Iq is determined based on the target torque when the windings 21u, 22u, 21v, 22v, 21w, and 22w are in a parallel connection state. The target torque is determined based on the rotation speed of the motor 20, the output torque of the motor 20, the depression amount of the brake pedal 70 (brake instruction amount), and the depression amount of the accelerator pedal 80 (acceleration instruction amount). As the motor current Iq increases, the motor torque also increases in a stepwise manner.

The output torque of the motor 20 decreases in a stepwise manner accompanying the switching of the connection state of the windings 21u, 22u, 21v, 22v, 21w, and 22w of the motor 20, and therefore the driver can be provided with a gear shift sensation similar to that of a mechanical transmission.

### Fourth Embodiment

In the fourth embodiment, the torque control unit 511 changes the effective current of the AC current output from the power converter 30 in a curved manner based on the gear shift timing.

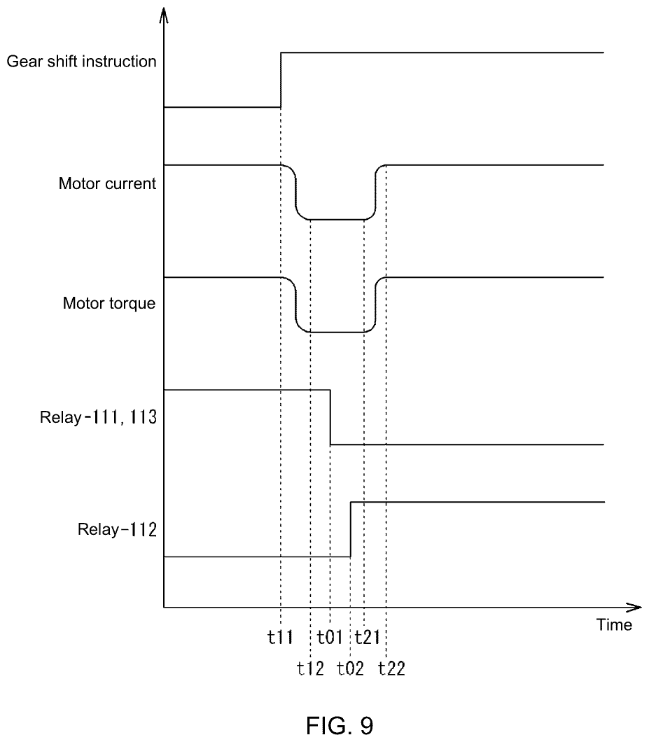

FIG. 9 is a timing chart showing an example of switching timing of the windings 21u, 22u, 21v, 22v, 21w, and 22w of the motor 20 in the winding switching system according to the fourth embodiment. FIG. 9 shows an example of timing of the gear shift instruction, the motor current, the motor torque, and the switching on/off of the semiconductor relays 111, 112, and 113 when the connection state of the windings 21u, 22u, 21v, 22v, 21w, and 22w of the motor 20 is switched from a series connection state to a parallel connection state.

At time t11, a gear shift instruction (electrical upshifting instruction) is input to the control device 50. The torque control unit 511 reduces the motor current Iq in a curved manner starting from time t11. In the example shown in FIG. 9, the slope of the decrease of the motor current Iq gradually increases starting from time t11, and the slope becomes infinite at the midpoint between time t11 and time t12. Thereafter, the slope of the decrease of the motor current Iq gradually decreases, and at time t12 the slope becomes 0 (the decrease stops).

At time t12, the motor current Iq reaches the first target value Th1. The torque control unit 511 stops the decrease of the motor current Iq at time t12 when the motor current Iq reaches the first target value Th1. That is, at time t12 and onward, the motor current Iq is maintained at the first target value Th1. At or after time t12, the decrease of the motor torque also stops.

At a timing at or after time t12, the switching control unit 512 switches the connection state of the windings 21u, 22u, 21v, 22v, 21w, and 22w from a series connection state to a parallel connection state. In the example of FIG. 9, at time t01, which is after time t12, the relays 111 and 113 are switched from the on state to the off state, and at time t02, which is after time t01, the relay 112 is switched from the off state to the on state. In the period of time between time t01 and time t02, all of the relays 111, 112, and 113 are in the off state. This prevents all of the relays 111, 112, and 113 from being turned on when the connection state of the windings 21u, 22u, 21v, 22v, 21w, and 22w is switched.

From time t21, which is after time t02, the torque control unit 511 increases the motor current Iq. At this time, the target value of the motor current Iq is determined based on the target torque when the windings 21u, 22u, 21v, 22v, 21w, and 22w are in a parallel connection state. The target torque is determined based on the rotation speed of the motor 20, the output torque of the motor 20, the depression amount of the brake pedal 70 (brake instruction amount), and the depression amount of the accelerator pedal 80 (acceleration instruction amount). In the example shown in FIG. 9, the motor current Iq increases in a curved manner. As the motor current Iq increases, the motor torque also increases.

In the example shown in FIG. 9, the slope of the increase of the motor current Iq gradually increases from time t21, and the slope becomes infinite at the midpoint between time t21 and time t22. Thereafter, the slope of the increase of the motor current Iq gradually decreases, and at time t22 the slope becomes 0 (the increase stops).

At time t22, the motor current Iq reaches the above-described target value. The torque control unit 511 stops the increase of the motor current Iq at time t22 when the motor current Iq reaches the target value. At or after time t22, the motor torque also stops increasing.

Accompanying the switching of the connection state of the windings 21u, 22u, 21v, 22v, 21w, and 22w of the motor 20, the output torque of the motor 20 decreases in a curved manner. In the fourth embodiment, since sharp changes in the motor torque are suppressed, it is possible to provide the driver with a gear shift sensation similar to that of a mechanical transmission.

### Fifth Embodiment

In the fifth embodiment, the torque control unit 511 executes virtual gear shift control processing to reduce and then increase the AC current output from the power converter 30 at a virtual gear shift timing different from the timing of the electrical upshifting and the electrical downshifting (electrical gear shift timing).

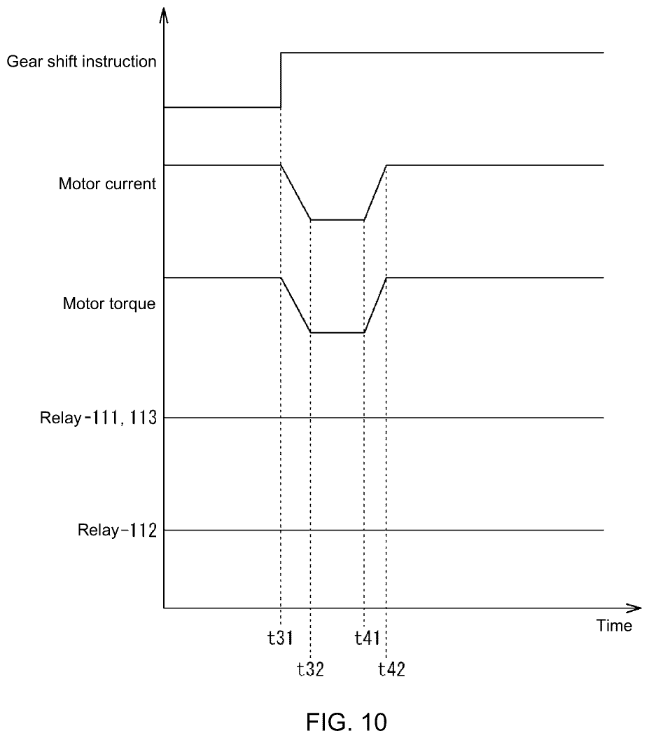

FIG. 10 is a timing chart showing an example of the virtual gear shift control processing in the winding switching system according to the fifth embodiment. FIG. 10 shows an example of timing of the gear shift instruction, the motor current, the motor torque, and switching on/off of the semiconductor relays 111, 112, and 113 when the connection state of the windings 21u, 22u, 21v, 22v, 21w, and 22w of the motor 20 is switched from a series connection state to a parallel connection state.

At time t31, a gear shift instruction (virtual gear shift instruction) is input to the control device 50. The torque control unit 511 reduces the motor current Iq starting from time t31. In the example shown in FIG. 10, the motor current Iq gradually decreases in a ramp shape. As the motor current Iq decreases, the motor torque also decreases.

At time t32, the motor current Iq reaches a first target value Th1. The torque control unit 511 stops the decrease of the motor current Iq at time t32 when the motor current Iq reaches the first target value Th1. That is, at time t32 and onward, the motor current Iq is maintained at the first target value Th1. At or after time t32, the decrease of the motor torque also stops.

The torque control unit 511 maintains the motor current Iq at the first target value Th1 for a certain period of time. During this period of time, the switching control unit 512 does not switch the connection state of the windings 21u, 22u, 21v, 22v, 21w, and 22w. That is, the semiconductor relays 111 and 113 maintain the on state, and the semiconductor relay 112 maintains the off state.

Starting from time t41, which is after time t32, the torque control unit 511 increases the motor current Iq. That is, the torque control unit 511 maintains the motor current Iq at the first target value Th1 for a certain period of time, and then increases it. Note that after the motor current Iq has decreased to the first target value Th1 or less, the torque control unit 511 may increase the motor current Iq without providing a stop period.

At this time, the target value of the motor current Iq is set to be the same as the target value before the change in the motor current Iq. In the example shown in FIG. 10, the motor current Iq increases in a ramp shape. As the motor current Iq increases, the motor torque also increases.

At time t42, the motor current Iq reaches the above described target value. The torque control unit 511 stops increasing the motor current Iq at time t42 when the motor current Iq reaches the target value. At or after time t42, the motor torque also stops increasing.

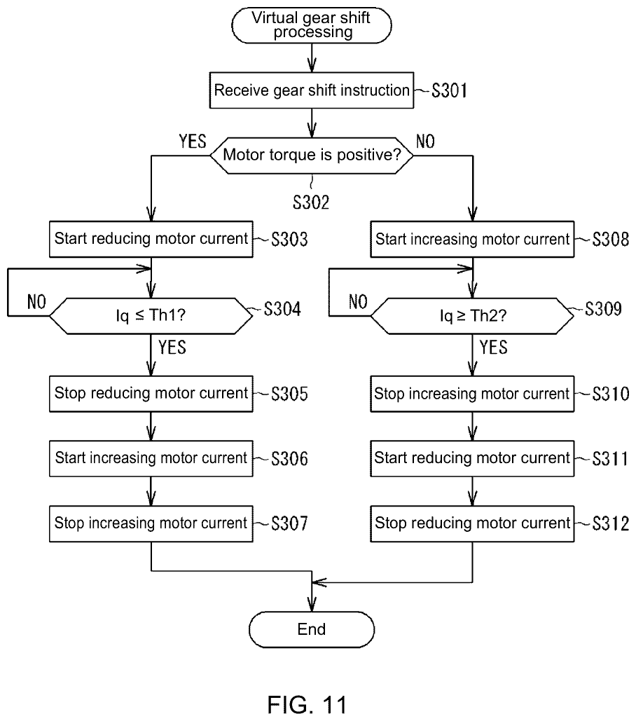

FIG. 11 is a flowchart showing an example of virtual gear shift processing performed by the control device according to the fifth embodiment.

The driver operates the gear shift indicator 90 to input a gear shift instruction to the vehicle. The processor 501 receives the gear shift instruction (step S301).

The processor 501 refers to the detection signal of the torque sensor 202 and judges whether or not the motor torque is positive, that is, whether or not the motor 20 is generating an acceleration torque (step S302).

If the motor torque is positive (YES in step S302), the processor 501 outputs an instruction to the power converter 30 to decrease the motor current Iq (step S303). This causes the motor current Iq to start decreasing.

The processor 501 acquires the current value of the motor current Iq from the detection signals of the current sensors 33u, 33v, and 33w, and judges whether or not the motor current Iq is less than or equal to the first target value Th1 (step S304).

If the motor current Iq is greater than the first target value Th1 (NO in step S304), the processor 501 executes step S304 again. If the motor current Iq is less than or equal to the first target value Th1 (YES in step S304), the processor 501 outputs an instruction to the power converter 30 to stop the decrease of the motor current Iq (step S305). This causes the motor current Iq to stop decreasing.

The processor 501 outputs an instruction to the power converter 30 to increase the motor current Iq without switching the connection state of the windings 21u, 22u, 21v, 22v, 21w, and 22w of the motor 20 (step S306). This causes the motor current Iq to start increasing.

When the motor current Iq reaches the same target value as the target value before the change of the motor current Iq, the processor 501 outputs an instruction to the power converter 30 to stop increasing the motor current Iq (step S307). This causes the motor current Iq to stop increasing. This ends the virtual gear shift processing performed when the motor torque is positive.

If the motor torque is negative (NO in step S302), the motor 20 is performing regenerative braking. In this case, the processor 501 outputs an instruction to the power converter 30 to increase the motor current Iq (step S308). This causes the motor current Iq to start increasing.

The processor 501 acquires the current value of the motor current Iq from the detection signals of the current sensors 33u, 33v, and 33w, and judges whether or not the motor current Iq is greater than or equal to the second target value Th2 (step S309).

If the motor current Iq is smaller than the second target value Th2 (NO in step S309), the processor 501 executes step S309 again. If the motor current Iq is greater than or equal to the second target value Th2 (YES in step S309), the processor 501 outputs an instruction to the power converter 30 to stop increasing the motor current Iq (step S310). This causes the motor current Iq to stop increasing.

The processor 501 outputs an instruction to the power converter 30 to reduce the motor current Iq without switching the connection state of the windings 21u, 22u, 21v, 22v, 21w, and 22w of the motor 20 (step S311). This causes the motor current Iq to start decreasing.

When the motor current Iq reaches the same target value as the target value before the change of the motor current Iq, the processor 501 outputs an instruction to the power converter 30 to stop the decrease of the motor current Iq (step S312). This causes the motor current Iq to stop decreasing. This ends the virtual gear shift processing performed when the motor torque is negative.

As described above, the output torque of the motor 20 changes in response to a gear shift instruction without switching the connection state of the windings 21u, 22u, 21v, 22v, 21w, and 22w of the motor 20, and therefore a driver can be provided with a virtual gear shift sensation also when no electrical gear shift is performed.

By combining the virtual gear shift processing described above with an electrical gear shift, it is possible to virtually cause the driver to feel a sensation of multi-stage gear shifting. For example, by performing virtual gear shift processing when switching between first and second gears, between second and third gears, between fourth and fifth gears, and between fifth and sixth gears, and performing electrical gear shift processing (electrical upshifting processing and electrical downshifting processing) when switching between third and fourth gears, it is possible to perform an electrical gear shift in which the performance of the motor is efficiently utilized when switching between third and fourth gears, while virtually causing the driver to feel a six stage gear shift sensation.

### Sixth Embodiment

The configuration of a winding switching system according to a sixth embodiment will be described with reference to FIG. 3.

The winding switching device 100 has voltage sensors 34u, 34v, and 34w that detect the voltages in the windings 21u, 21v, and 21w. In a specific example, the voltage sensor 34u is arranged between a power line 35u and a power line 212u, the voltage sensor 34v is arranged between a power line 35v and a power line 212v, and the voltage sensor 34w is arranged between a power line 35w and a power line 212w. The voltage sensors 34u, 34v, and 34w are connected to a control device 50. The control device 50 can receive the detection values of the voltage sensors 34u, 34v, and 34w.

Other configurations of the winding switching system according to the sixth embodiment are the same as those of the winding switching system 10 according to the first embodiment, and therefore identical components are denoted by identical reference numerals and description thereof is omitted.

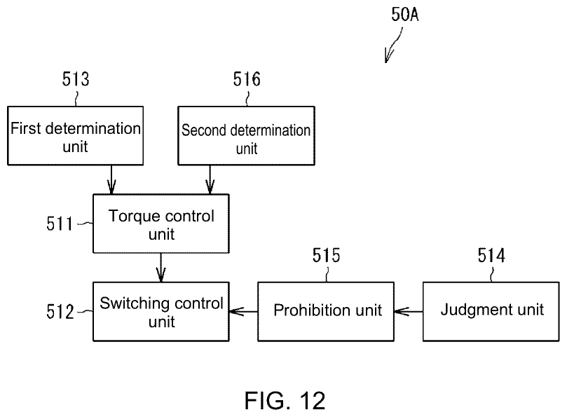

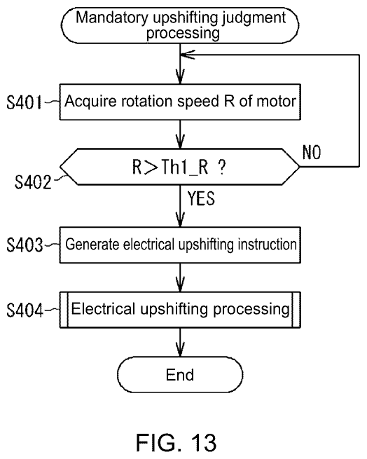

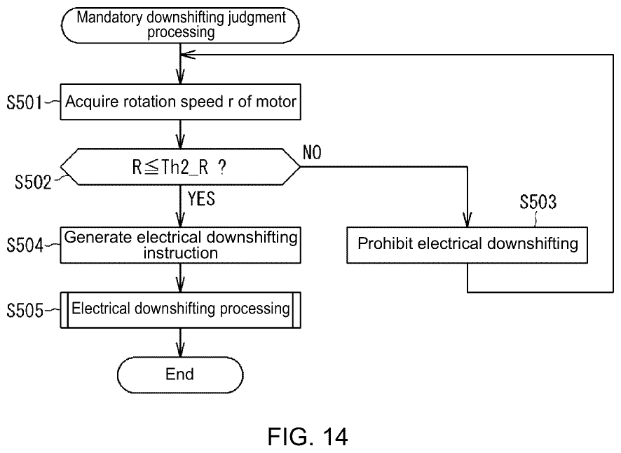

FIG. 12 is a functional block diagram showing an example of functions of a control device according to the sixth embodiment. A control device 50A includes the functions of a first determination unit 513, a judgment unit 514, a prohibition unit 515, and a second determination unit 516, in addition to the torque control unit 511 and the switching control unit 512.

The functions of the torque control unit 511 and the switching control unit 512 are the same as those in the first embodiment, and therefore detailed description thereof is omitted.

The first determination unit 513 determines, when the connection state of the plurality of windings 21u, 22u, 21v, 22v, 21w, and 22w is a series connection state, the timing before the induced voltage generated in the windings 21u, 22u, 21v, 22v, 21w, and 22w exceeds the output voltage of the battery 40, as a first mandatory gear shift timing. The first mandatory gear shift timing is the timing for starting to mandatorily switch the connection state of the windings 21u, 22u, 21v, 22v, 21w, and 22w from a series connection state to a parallel connection state, regardless of whether or not there is a gear shift instruction from the shift indicator 90 or an automatic gear shift control device.

An induced voltage corresponding to the rotation speed of the motor 20 is generated in the windings 21u, 22u, 21v, 22v, 21w, and 22w. The power converter 30 can control the voltage applied to the windings 21u, 22u, 21v, 22v, 21w, and 22w within the range of the output voltage of the battery 40. Since the polarity of the induced voltage in the windings 21u, 22u, 21v, 22v, 21w, and 22w is opposite to the polarity of the applied voltage, when the induced voltage exceeds the output voltage of battery 40, the current in the windings 21u, 22u, 21v, 22v, 21w, and 22w can no longer be reduced to zero. Accordingly, when the first target value Th1 is 0 A, if the induced voltage exceeds the output voltage of the battery 40, the motor current Iq cannot be reduced to the first target value Th1 in the electrical upshifting processing.

In view of this, in the sixth embodiment, the first determination unit 513 monitors the induced voltage generated in the windings 21u, 22u, 21v, 22v, 21w, and 22w in the series connection state, and determines a timing before the induced voltage transitions from a range less than or equal to the output voltage of the battery 40 to a range exceeding the output voltage as the first mandatory gear shift timing.

The torque control unit 511 changes the AC current output from the power converter 30 at the first mandatory gear shift timing determined by the first determination unit 513, thereby changing the output torque of the motor 20. After the AC current has changed, the switching control unit 512 causes the winding switching device 100 to switch the connection state of the windings 21u, 22u, 21v, 22v, 21w, and 22w from the series connection state to the parallel connection state.

In a specific example, when the first determination unit 513 determines the first mandatory gear shift timing, the first determination unit 513 generates an electrical upshifting instruction. This starts the electrical upshifting processing.

In a specific example, the first determination unit 513 can determine the timing at which a physical quantity related to the induced voltage exceeds a first threshold value corresponding to the output voltage of the battery 40 as the first mandatory gear shift timing. The physical quantity is, for example, the rotation speed of the motor 20. In this case, the first determination unit 513 can acquire a detection value from the rotation sensor 201. Another example of a physical quantity is the voltage in the windings 21u, 21v, and 21w. In this case, detection values can be acquired from each of the voltage sensors 34u, 34v, and 34w. The physical quantity may also be the current flowing through the windings 21u, 22u, 21v, 22v, 21w, and 22w, or the output torque of the motor 20. In the following description, the physical quantity is the rotation speed of the motor 20.

The judgment unit 514 judges whether or not the induced voltage exceeds the output voltage of the battery after the connection state of the windings 21u, 22u, 21v, 22v, 21w, and 22w has been switched from the parallel connection state to the series connection state when the connection state of the plurality of windings 21u, 22u, 21v, 22v, 21w, and 22w is a parallel connection state.

In a specific example, the judgment unit 514 can judge whether or not the physical quantity related to the induced voltage in a series connection state is less than or equal to a second threshold value corresponding to the output voltage of the battery 40. More specifically, the judgment unit 514 acquires the rotation speed of the motor 20. The induced voltage when the windings 21u, 22u, 21v, 22v, 21w, and 22w are in a series connection state can be specified based on the rotation speed of the motor 20. The second threshold value is, for example, the rotation speed of the motor 20 when the induced voltage becomes equal to the output voltage of the battery 40 in the case where the windings 21u, 22u, 21v, 22v, 21w, and 22w are in a series connection state. However, the second threshold is not limited to this. For example, the second threshold value may also be the rotation speed of the motor 20 when the induced voltage is lower than the output voltage of the battery 40 by a predetermined margin in the case where the windings 21u, 22u, 21v, 22v, 21w, and 22w are in a series connection state.

When the judgment unit 514 judges that the induced voltage exceeds the output voltage of the battery 40, the prohibition unit 515 prohibits the switching control unit 512 from performing switching control on the connection state of the windings 21u, 22u, 21v, 22v, 21w, and 22w. In a specific example, the prohibition unit 515 prohibits the switching control unit 512 from performing switching control on the connection state of the windings 21u, 22u, 21v, 22v, 21w, and 22w while the rotation speed of the motor 20 exceeds the second threshold value. The prevents the connection state of the windings 21u, 22u, 21v, 22v, 21w, and 22w from being switched from a parallel connection state to a series connection state, and prevents the induced voltage from exceeding the output voltage of the battery 40.

When the rotation speed of the motor 20 is less than or equal to the second threshold value, the prohibition unit 515 cancels the prohibition of the switching control unit 512 from performing switching control on the connection state of the windings 21u, 22u, 21v, 22v, 21w, and 22w.

When the connection state of the plurality of windings 21u, 22u, 21v, 22v, 21w, 22w is a parallel connection state, the second determination unit 516 determines a timing after the induced voltage has become less than or equal to the output voltage of the battery 40 after the connection state of the windings 21u, 22u, 21v, 22v, 21w, 22w has been switched from the parallel connection state to the series connection state, as a second mandatory gear shift timing. The second mandatory gear shift timing is the timing for starting to mandatorily switch the connection state of the windings 21u, 22u, 21v, 22v, 21w, and 22w from a parallel connection state to a series connection state, regardless of whether or not there is a gear shift instruction from the shift indicator 90 or the automatic gear shift control device.

In the series connection state, regenerative power can be recovered more efficiently than in the parallel connection state. Furthermore, in the series connection state, the higher the rotation speed of the motor 20 is, the greater the amount of regeneration is. Accordingly, for example, when the vehicle is decelerating in the parallel connection state, in order to efficiently recover regenerative power, it is preferable to perform electrical downshifting at a timing when the rotation speed of the motor 20 is as high as possible when the induced voltage after switching to the series connection state is within a range less than or equal to the output voltage of the battery 40.

The second determination unit 516 estimates the induced voltage generated in the windings 21u, 22u, 21v, 22v, 21w, and 22w in the series connection state, and determines the timing at which the induced voltage transitions from a range exceeding the output voltage of the battery 40 to a range less than or equal to the output voltage of the battery 40 as the second mandatory gear shift timing.

The torque control unit 511 changes the output torque of the motor 20 by changing the AC current output from the power converter 30 at the second mandatory gear shift timing determined by the second determination unit 516. After the AC current has changed, the switching control unit 512 causes the winding switching device 100 to switch the connection state of the windings 21u, 22u, 21v, 22v, 21w, and 22w from the parallel connection state to the series connection state.

In a specific example, when the second determination unit 516 determines the second mandatory gear shift timing, the second determination unit 516 generates an electrical downshifting instruction. This starts the electrical downshifting processing.

In a specific example, the second determination unit 516 can determine the timing at which the physical quantity related to the induced voltage becomes less than or equal to the second threshold value corresponding to the output voltage of the battery 40 as the second mandatory gear shift timing. For example, the second determination unit 516 determines the timing at which the rotation speed of the motor 20 becomes less than or equal to the second threshold value as the second mandatory gear shift timing.

The operation of the winding switching system according to the sixth embodiment will be described below. The control device 50A executes the following mandatory upshifting judgment processing and mandatory downshifting judgment processing.

FIG. 13 is a flowchart showing an example of mandatory upshifting judgment processing performed by the control device according to the sixth embodiment. In this example, it is assumed that the windings 21u, 22u, 21v, 22v, 21w, and 22w of the motor 20 are in a series connection.

The rotation sensor 201 detects the rotation speed of the output shaft of the motor 20, and outputs the detected rotation speed. For example, the rotation sensor 201 detects the rotation speed at a constant period and outputs the detection result. The control device 50A receives the detection value of the rotation speed output from the rotation sensor 201 (step S401).

The processor 501 compares the acquired rotation speed R with a first threshold value Th1_R, and judges whether or not the rotation speed R exceeds the first threshold value Th1_R (step S402), The first threshold value Th1_R is a value lower by a predetermined margin than the rotation speed of the motor 20 when the induced voltage generated in the windings 21u, 22u, 21v, 22v, 21w, and 22w in a series connection state matches the output voltage of the battery 40.

If the rotation speed R is less than or equal to the first threshold value Th1_R (NO in step S402), the processor 501 returns to step S401.

If the rotation speed R exceeds the first threshold value Th1_R (YES in step S402), the processor 501 determines that timing as the first mandatory gear shift timing. The processor 501 generates an electrical upshifting instruction (step S403).

Next, the processor 501 starts electrical upshifting processing (step S404). As a result, after the motor current Iq has been reduced, the connection state of the windings 21u, 22u, 21v, 22v, 21w, and 22w is switched from a series connection state to a parallel connection state. This completes the mandatory upshifting judgment processing.

FIG. 14 is a flowchart showing an example of mandatory downshifting judgment processing performed by the control device according to the sixth embodiment. In this example, it is assumed that the windings 21u, 22u, 21v, 22v, 21w, and 22w of the motor 20 are in a parallel connection.

The control device 50A receives the detection value of the rotation speed output from the rotation sensor 201 (step S501).

The processor 501 compares the acquired rotation speed R with a second threshold value Th2_R, and judges whether or not the rotation speed R is less than or equal to the second threshold value Th2_R (step S502). The second threshold value Th2_R is a value lower by a predetermined margin than the rotation speed of the motor 20 when the induced voltage generated in the windings 21u, 22u, 21v, 22v, 21w, and 22w in the series connection state matches the output voltage of the battery 40. The second threshold value Th2_R may be the same as the first threshold value Th1_R, or may be a different value. For example, the second threshold value Th2_R is a value lower than the first threshold value Th1_R. This makes it possible to prevent the rotation speed R from exceeding the first threshold value Th1_R shortly after the electrical downshifting is completed, and to prevent mandatory upshifting from being executed.

If the rotation speed R is greater than the second threshold value Th2_R (NO in step S502), the processor 501 prohibits electrical downshifting (step S503). As a result, even if an electrical downshifting instruction is issued by the driver, for example, electrical downshifting is not executed. With the electrical downshifting prohibited, the processor 501 returns to step S501.

If the rotation speed R is less than or equal to the second threshold value Th2_R (YES in step S502), the processor 501 determines that timing as the second mandatory gear shift timing. In this case, if electrical downshifting is prohibited, the processor 501 cancels the prohibition of electrical downshifting. When the processor 501 determines the second mandatory gear shift timing, the processor 501 generates an electrical downshifting instruction (step S504).

Next, the processor 501 starts the electrical downshifting processing (step S505). As a result, after the motor current Iq approaches zero, the connection state of the windings 21u, 22u, 21v, 22v, 21w, and 22w switches from a parallel connection state to a series connection state. This ends the mandatory downshifting judgment processing.

### Supplementary Note

The embodiments disclosed herein are exemplary in all respects and are not restrictive. The scope of the present disclosure is indicated not by the above-described embodiments, but by the claims, and encompasses meanings equivalent to the claims and all modifications within the scope thereof.

1. A winding switching system for a vehicle motor, comprising:
a drive motor configured to drive a wheel of a vehicle;
a control device configured to control the drive motor;
a power converter configured to convert DC power output from a battery into AC power and supply the AC power to the drive motor; and
a winding switching device configured to switch a connection state of a plurality of windings in the drive motor between a first connection state and a second connection state,
wherein the control device includes:
a torque control unit configured to change an output torque of the drive motor by changing an AC current output from the power converter at a predetermined gear shift timing of the vehicle; and
a switching control unit configured to cause the winding switching device to switch from the first connection state to the second connection state after the AC current has changed.

2. The winding switching system for a vehicle motor according to claim 1,
wherein the torque control unit reduces the output torque of the drive motor by reducing the AC current output from the power converter at a first gear shift timing, and
the switching control unit causes the winding switching device to switch from the first connection state to the second connection state after the AC current has decreased to a first target value or less.

3. The winding switching system for a vehicle motor according to claim 2,
wherein the torque control unit reduces the output torque of the drive motor by reducing the AC current output from the power converter at a second gear shift timing different from the first gear shift timing, and
the switching control unit causes the winding switching device to switch from the second connection state to the first connection state after the AC current has decreased to the first target value or less.

4. The winding switching system for a vehicle motor according to claim 1,
wherein the torque control unit increases the output torque of the drive motor by increasing the AC current output from the power converter at a first gear shift timing, and
the switching control unit causes the winding switching device to switch from the first connection state to the second connection state after the AC current has increased to a second target value or more.

5. The winding switching system for a vehicle motor according to claim 4,
wherein the torque control unit increases the output torque of the drive motor by increasing the AC current output from the power converter at a second gear shift timing different from the first gear shift timing, and
the switching control unit causes the winding switching device to switch from the second connection state to the first connection state after the AC current has increased to a second target value or more.

6. The winding switching system for a vehicle motor according to claim 1, wherein the second connection state is a connection state for the driving motor to output a lower torque than in the first connection state at the same rotation speed.

7. The winding switching system for a vehicle motor according to claim 6,
wherein the control device further includes a first determination unit configured to determine, when the connection state of the plurality of windings is the first connection state, a timing before an induced voltage generated in the windings exceeds an output voltage of the battery, as a first mandatory gear shift timing,
the torque control unit changes the output torque of the drive motor by changing the AC current output from the power converter at the first mandatory gear shift timing determined by the first determination unit, and
the switching control unit causes the winding switching device to switch from the first connection state to the second connection state after the AC current has changed.

8. The winding switching system for a vehicle motor according to claim 7, wherein the first determination unit determines, as the first mandatory gear shift timing, a timing at which a physical quantity related to the induced voltage exceeds a first threshold value corresponding to the output voltage of the battery.

9. The winding switching system for a vehicle motor according to claim 8, wherein the physical quantity is one of a voltage in the windings, a rotation speed of the drive motor, a current flowing through the windings, and the output torque of the drive motor.

10. The winding switching system for a vehicle motor according to claim 7,
the control device further includes:
a judgment unit configured to, when the connection state of the plurality of windings is the second connection state, judge whether or not the induced voltage exceeds the output voltage of the battery after the connection state of the windings has been switched from the second connection state to the first connection state; and
a prohibition unit configured to prohibit the switching control unit from switching the connection state of the windings if the judgment unit judges that the induced voltage exceeds the output voltage of the battery.

11. The winding switching system for a vehicle motor according to claim 7,
wherein the control device further includes a second determination unit configured to, when the connection state of the plurality of windings is the second connection state, determine a timing after the induced voltage has become less than or equal to the output voltage of the battery after the connection state of the plurality of windings has been switched from the second connection state to the first connection state, as a second mandatory gear shift timing,
the torque control unit changes the output torque of the drive motor by changing the AC current output from the power converter at the second mandatory gear shift timing determined by the second determination unit, and
the switching control unit causes the winding switching device to switch from the second connection state to the first connection state after the AC current has changed.

12. The winding switching system for a vehicle motor according to claim 11, wherein the second determination unit determines, as the second mandatory gear shift timing, a timing at which the physical quantity related to the induced voltage becomes less than or equal to a second threshold value corresponding to the output voltage of the battery.

13. The winding switching system for a vehicle motor according to,
wherein the winding switching system further includes an input device configured to receive a gear shift instruction from a driver, and
the gear shift timing is a timing at which the input device receives the gear shift instruction from the driver.

14. The winding switching system for a vehicle motor according to claim 1, wherein the gear shift timing is a timing that is determined based on a rotation speed of the drive motor, the output torque, an acceleration instruction amount of the vehicle, and a braking instruction amount of the vehicle.

15. The winding switching system for a vehicle motor according to claim 1, wherein the torque control unit gradually decreases or gradually increases an effective current of the AC current output from the power converter, starting from the gear shift timing.

16. The winding switching system for a vehicle motor according to claim 15, wherein the torque control unit changes the effective current in a ramp shape, starting from the gear shift timing.

17. The winding switching system for a vehicle motor according to claim 1, wherein the torque control unit changes an effective current of the AC current output from the power converter in a stepwise manner based on the gear shift timing.

18. The winding switching system for a vehicle motor according to claim 1, wherein the torque control unit executes virtual gear shift control processing for decreasing and then increasing the AC current output from the power converter at a virtual gear shift timing different from the gear shift timing.

19. A control device for controlling a drive motor that drives a wheel of a vehicle, comprising:
a torque control unit configured to change an output torque of the drive motor by changing an AC current output from a power converter configured to convert DC power output from a battery into AC power and supply the AC power to the drive motor, at a predetermined gear shift timing of the vehicle; and
a switching control unit configured to cause a winding switching device configured to switch a connection state of a plurality of windings in the driving motor to switch from a first connection state to a second connection state after the AC current has changed.

20. A control method for a vehicle motor, to be executed by a control device for controlling a drive motor that drives a wheel of a vehicle, the control method comprising:
a step of changing an output torque of the drive motor by changing an AC current output from a power converter configured to convert DC power output from a battery into AC power and supply the AC power to the drive motor, at a predetermined gear shift timing of the vehicle; and
a step of causing a winding switching device configured to switch a connection state of a plurality of windings in the driving motor to switch from a first connection state to a second connection state after the AC current has changed.

21. (canceled)
